(19) United States
(12) Patent Application Publication
(10) Pub. No.: US 2026/0207403 A1
(43) Pub. Date: Jul. 23, 2026

(54) ELECTRIC CYLINDER AND RELEASE STRUCTURE THEREOF

(71) Applicant: TIMOTION TECHNOLOGY CO., LTD., New Taipei City (TW)

(72) Inventor: Yu-Chang LIN, New Taipei City (TW)

(21) Appl. No.: 19/366,288

(22) Filed: Oct. 22, 2025

Related U.S. Application Data
(60) Provisional application No. 63/748,439, filed on Jan. 23, 2025.

(51) Int. Cl. A61G 7/018; A61G 7/015; F16H 25/24; H02K 7/116

(52) U.S. Cl. CPC A61G 7/018; F16H 25/2418; F16H 25/2454; H02K 7/1166; A61G 7/015

(57) ABSTRACT

An electric cylinder and a release structure are provided. The release structure includes an end joint, a connection seat, and a bearing member. The end joint includes a head and a shaft extending from the head having first engagement portions. The connection seat is sleeved on the shaft, connected to an inner tube, and provided with second engagement portions operable to engage or disengage from the first engagement portions. The bearing member is sleeved on the shaft at one side of the connection seat. In a non-locking state, the first engagement portions and the second engagement portions are disengaged, allowing the connection seat and the inner tube to freely rotate relative to the end joint. In a locking state, the first engagement portions and the second engagement portions are engaged, such that the end joint and the connection seat move with the inner tube.

### CROSS-REFERENCE TO RELATED APPLICATION

This patent application claims the benefit of U.S. Provisional Patent Application No. 63/748,439 , filed Jan. 23, 2025, which is incorporated by reference herein.

### BACKGROUND OF THE DISCLOSURE

### Technical Field

The present disclosure relates to a technical field of electric cylinders, and particularly to an electric cylinder and a release structure thereof.

### Description of Related Art

The use of electric cylinders in electric beds, medical beds, hospital beds, electric lifting tables, or electric lifting chairs for adjusting height or inclination has become quite common. Among them, medical beds are mostly provided for elderly users or users with limited mobility. During long-term use, the surrounding environment inevitably accumulates dust, residues, or debris that require cleaning.

A conventional medical bed generally includes an upper section, a middle section, and a lower section that are connected to each other. The electric cylinder generally includes an actuating body and a rear bracket connected to a rear end of the actuating body. The rear bracket is connected to the middle section of the medical bed by a pin, while the end of the actuating body away from the rear bracket is connected to the lower section of the medical bed by another pin. When it is necessary to clean the space beneath the medical bed, the actuating body is operated to lift the lower section of the bed, thereby facilitating cleaning.

However, the raising and lowering of the lower section or upper section usually requires the operation of an electric motor, which drives a lead screw to transmit linear extension or retraction movement of an inner tube in order to achieve the aforementioned lifting action. The lifting process is subject to physical limitations and consumes a considerable amount of waiting time for the cleaning personnel.

In view of this, the applicant devoted research efforts to addressing the deficiencies of the related art and, through theoretical application, endeavored to resolve the above problems, which is the objective of the present improvement.

### SUMMARY OF THE INVENTION

An objective of the present disclosure is to provide an electric cylinder and a release structure thereof, which allow a connection seat and an end joint to be quickly separated, thereby reducing the time consumed during handling.

To achieve the above objective, the present disclosure provides a release structure of an electric cylinder. The electric cylinder includes an inner tube, and the release structure is disposed on the inner tube. The release structure includes an end joint, a connection seat, and a bearing member. The end joint includes a head and a shaft extending from the head, wherein a plurality of first engagement portions are disposed on the head. The connection seat is sleeved on the shaft and connected to the inner tube, the connection seat is provided with a plurality of second engagement portions, and the second engagement portions are respectively operable to engage with or disengage from the first engagement portions. The bearing member is sleeved on the shaft and disposed at one side of the connection seat. In a non-locking state, the first engagement portions and the second engagement portions are disengaged, such that the connection seat and the inner tube are rotatable relative to the end joint. In a locking state, the first engagement portions and the second engagement portions are engaged, such that the end joint and the connection seat move together with the inner tube.

To achieve the above objective, the present disclosure provides an electric cylinder, including a housing, an electric motor, a transmission mechanism, a quick-release mechanism, and a release structure. The electric motor is connected to the housing. The transmission mechanism is connected to the housing and driven by the electric motor, and includes a lead screw, an inner tube, and a nut. The nut is connected to one end of the inner tube and threadedly engaged with the lead screw for transmission. The quick-release mechanism is sleeved on the lead screw. The release structure is disposed at another end of the inner tube and includes an end joint, a connection seat, and a bearing member. The end joint includes a head and a shaft extending from the head, with a plurality of first engagement portions disposed on the head. The connection seat is sleeved on the shaft and connected to the inner tube, and is provided with a plurality of second engagement portions, the second engagement portions being respectively operable to engage with or disengage from the first engagement portions. The bearing member is sleeved on the shaft and disposed at one side of the connection seat. In a non-locking state, the first engagement portions and the second engagement portions are disengaged, such that the connection seat and the inner tube are rotatable relative to the end joint. In a locking state, the first engagement portions and the second engagement portions are engaged, such that the end joint and the connection seat move together with the inner tube.

The present disclosure also provides the following effect. When the end joint and the connection seat are in a non-locking state, the lower section of a medical bed may be moved relative to the middle section; after release, when the end joint and the connection seat are in a locking state, by virtue of the self-locking effect of the electric cylinder itself, the inner tube does not retract.

### BRIEF DESCRIPTION OF THE DRAWINGS

FIG. 1 is an assembled perspective view of an electric cylinder according to the present disclosure.

FIG. 2 is an assembled perspective view of the electric cylinder of the present disclosure in a state where an inner tube is extended outward.

FIG. 3 is an exploded view illustrating a release structure and the inner tube of the present disclosure.

FIG. 4 is an exploded view of the release structure of the present disclosure.

FIG. 5 is another exploded view of the release structure of the present disclosure from a different direction.

FIG. 6 is an assembled cross-sectional view of the electric cylinder of the present disclosure and a partially enlarged view of the release structure.

FIG. 7 is a cross-sectional view illustrating a first usage state of the electric cylinder of the present disclosure.

FIG. 8 is a cross-sectional view illustrating a second usage state of the electric cylinder of the present disclosure.

FIG. 9 is a cross-sectional view illustrating a third usage state of the electric cylinder of the present disclosure.

### DETAILED DESCRIPTION

The detailed description and technical content of the present disclosure are explained below in conjunction with the drawings. However, the attached drawings are provided for reference and illustration only, and are not intended to limit the present disclosure.

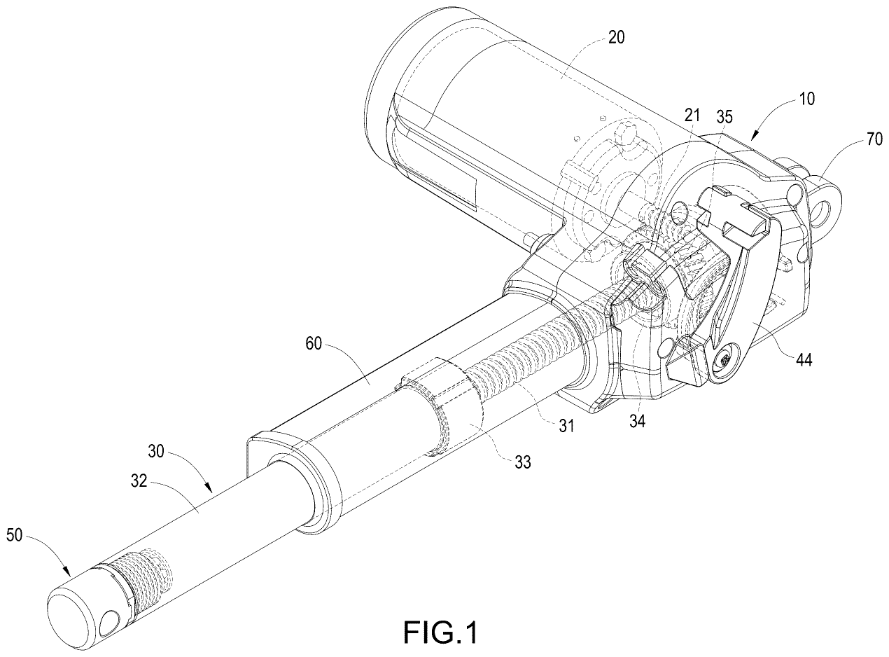

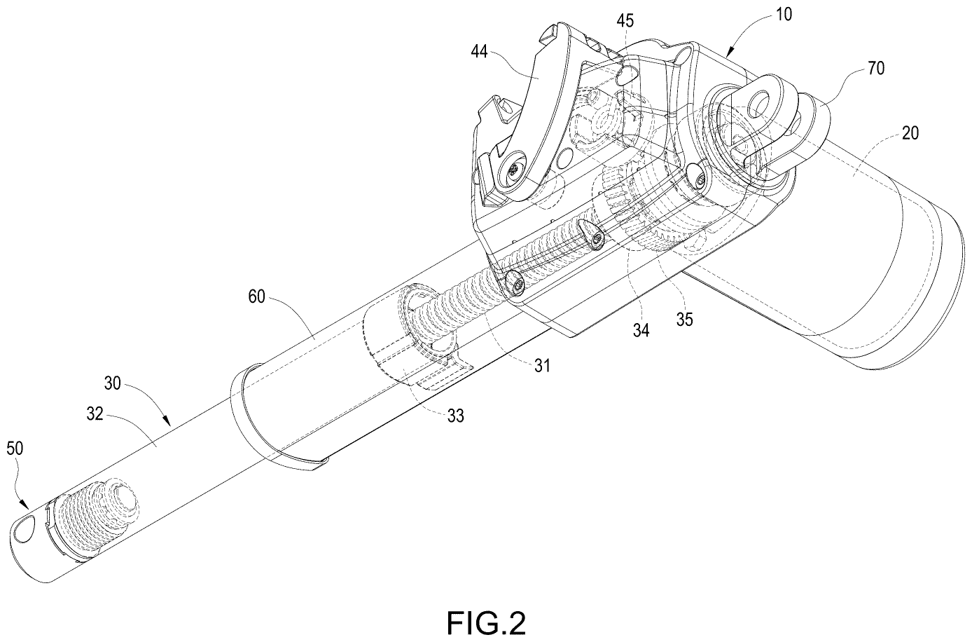

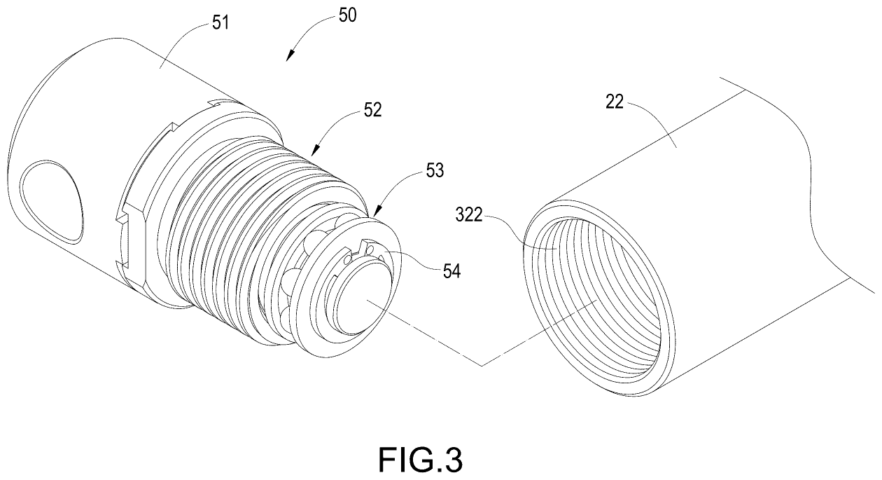

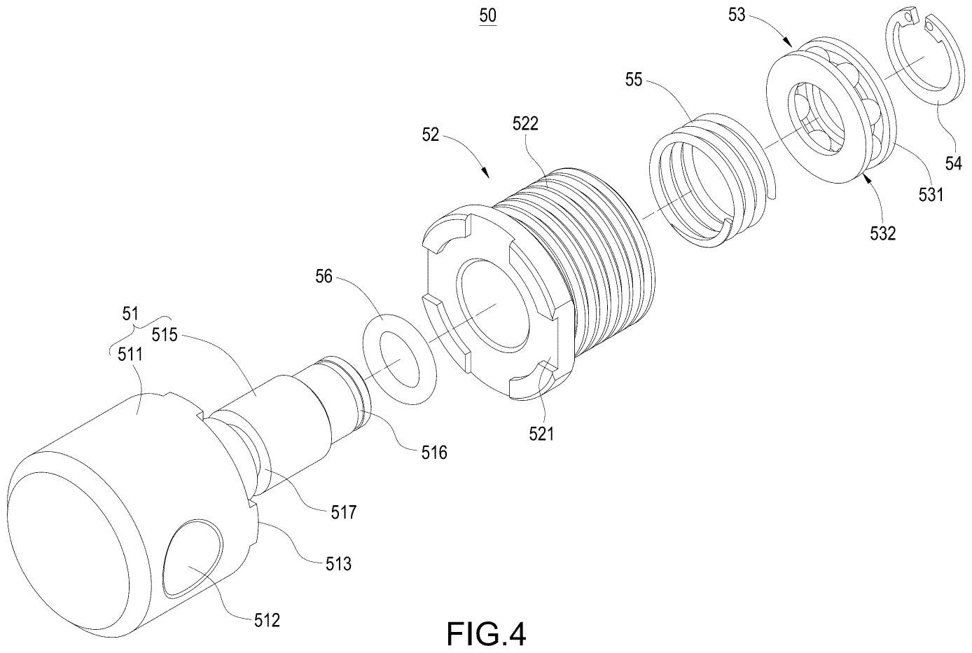

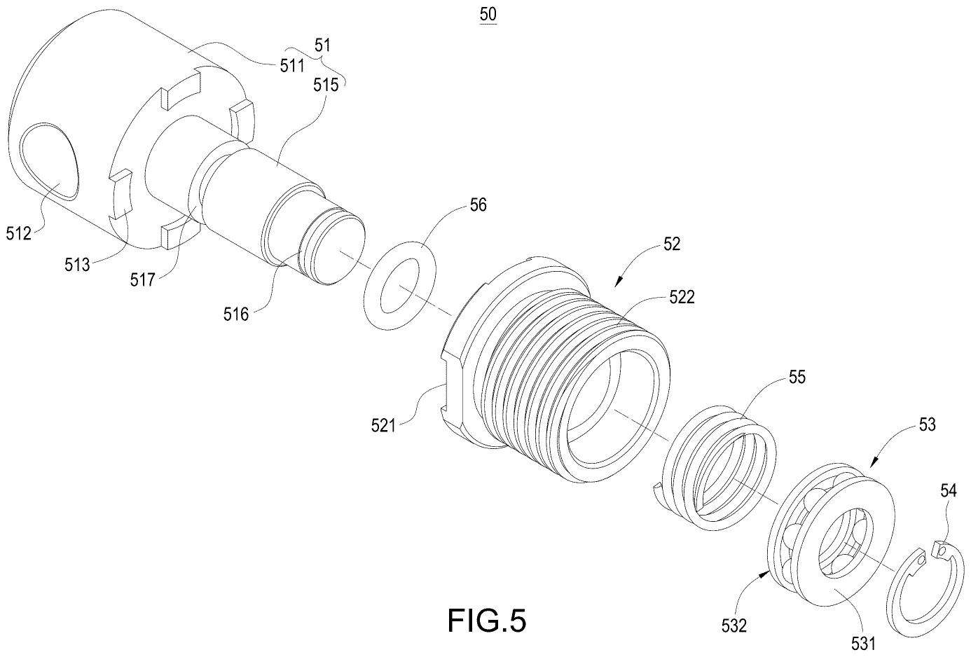

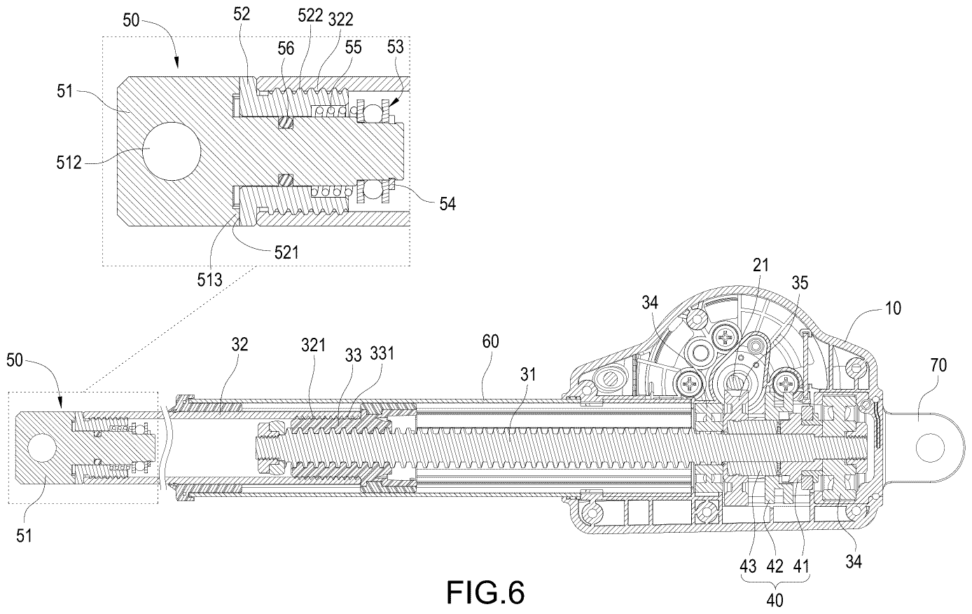

Please refer to FIGS. 1 to 6. The present disclosure provides an electric cylinder and a release structure thereof. The electric cylinder mainly includes a housing 10, an electric motor 20, a transmission mechanism 30, a quick-release mechanism 40, a release structure 50, an outer tube 60, a rear bracket 70, and other related components or devices.

In the present embodiment, the electric cylinder mainly includes a housing 10, an electric motor 20, a transmission mechanism 30, a quick-release mechanism 40, a release structure 50, an outer tube 60, a rear bracket 70, and other related components or devices.

The electric motor 20 is fixed to one side of the housing 10. The transmission mechanism 30 is disposed on the housing 10, driven by the electric motor 20, and together with the electric motor 20 generally forms an L shape. The quick-release mechanism 40 is arranged inside the housing 10 and located at one end of the transmission mechanism 30. The release structure 50 is disposed at the other end of the transmission mechanism 30 away from the quick-release mechanism 40. One end of the outer tube 60 is connected to the housing 10 and extends circumferentially around the outer periphery of the transmission mechanism 30. The rear bracket 70 is connected to the housing 10 and disposed at a rear side of the transmission mechanism 30.

The electric motor 20 includes a worm 21. The transmission mechanism 30 mainly includes a lead screw 31, an inner tube 32, a nut 33, two bearings 34, and a worm gear 35. The lead screw 31 passes through the bearings 34 and is supported on the housing 10 by the bearings 34. Two ends of the inner tube 32 are respectively provided with a first internal thread 321 and a second internal thread 322. The nut 33 is provided with a first external thread 331, and the nut 33 is fixedly threaded into the first internal thread 321 through the first external thread 331. The nut 33 is threadedly engaged with the lead screw 31 by means of its internal thread for transmission. The worm gear 35 is sleeved on the lead screw 31 and engaged with the worm 21, such that the rotation of the worm 21 drives the worm gear 35 and the lead screw 31 to rotate together.

The quick-release mechanism 40 mainly includes a fixed wheel 41, a clutch wheel 42, a guide member 43, a handle 44, and an actuating assembly 45. The guide member 43 and the fixed wheel 41 are sequentially sleeved on the lead screw 31 and accommodated inside the housing 10, wherein the worm gear 35 is connected to the lead screw 31 through the guide member 43. The clutch wheel 42 is movably sleeved on the guide member 43, and engagement grooves and engagement blocks are provided on end surfaces of the clutch wheel 42 and the fixed wheel 41 to form a clutch (not shown). The handle 44 is pivotally connected to the outside of the housing 10, and the actuating assembly 45 is disposed inside the housing 10 and connected to the handle 44 and the clutch wheel 42, such that by the pivoting operation of the handle 44, the clutch wheel 42 moves axially along the guide member 43 and thereby engages or disengages from the fixed wheel 41.

The release structure 50 is disposed at an end of the inner tube 32 away from the nut 35, and mainly comprises an end joint 51, a connection seat 52, and a bearing member 53. The end joint 51 mainly includes a head 511 and a shaft 515 extending from the head 511. The head 511 is generally cylindrical, provided with a through hole 512 in a radial direction, and further provided with a plurality of first engagement portions 513 adjacent to the shaft 515. The first engagement portions 513 are arranged at equal intervals around an end surface of the head 511. In this embodiment, each first engagement portion 513 is an engagement block, but is not limited thereto. An end of the shaft 515 away from the head 511 is provided with a retaining groove 516 configured to receive a retaining ring 54 for connection.

The connection seat 52 is a hollow cylindrical column sleeved on the shaft 515 and connected to the inner tube 32. A plurality of second engagement portions 521 are provided on an end surface of the connection seat 52 adjacent to the end joint 51, operable to engage with or disengage from the first engagement portions 513. In this embodiment, each second engagement portion 521 is an engagement groove, but is not limited thereto. In addition, an outer circumferential surface of the connection seat 52 is provided with a second external thread 522, by which the connection seat 52 is threadedly fixed to the second internal thread 322 of the inner tube 32.

In this embodiment, the bearing member 53 is a thrust bearing, but is not limited thereto. The bearing member 53 mainly includes a stationary portion 531 and a rotating portion 532 movably connected to the stationary portion 531. The stationary portion 531 is secured to the shaft 515, and the rotating portion 532 abuts one side of the connection seat 52. The bearing member 53 is held in place on the shaft 515 by the retaining ring 54. The stationary portion 531 remains immovable due to the frictional force between the stationary portion 531 and the end surface of the retaining ring 54. The rotating portion 532 abuts the end surface of the connection seat 52 and, as a result, rotates together with the connection seat 52.

In a non-locking state, the first engagement portions 513 and the second engagement portions 521 are disengaged, such that the connection seat 52 and the inner tube 32 may freely rotate relative to the end joint 51. In a locking state, the first engagement portions 513 and the second engagement portions 521 are engaged, such that the end joint 51 and the connection seat 52 move together.

In one embodiment, the release structure 50 further comprises a return spring 55 sleeved on the shaft 515 and elastically clamped between the connection seat 52 and the bearing member 53, so as to provide a restoring force to the end joint 51.

In one embodiment, the release structure 50 further includes a sealing ring 56. The shaft 515 is further provided with a groove 517, and the sealing ring 56 is disposed in the groove 517 to prevent external moisture, dust, or other substances from entering the inner tube 32.

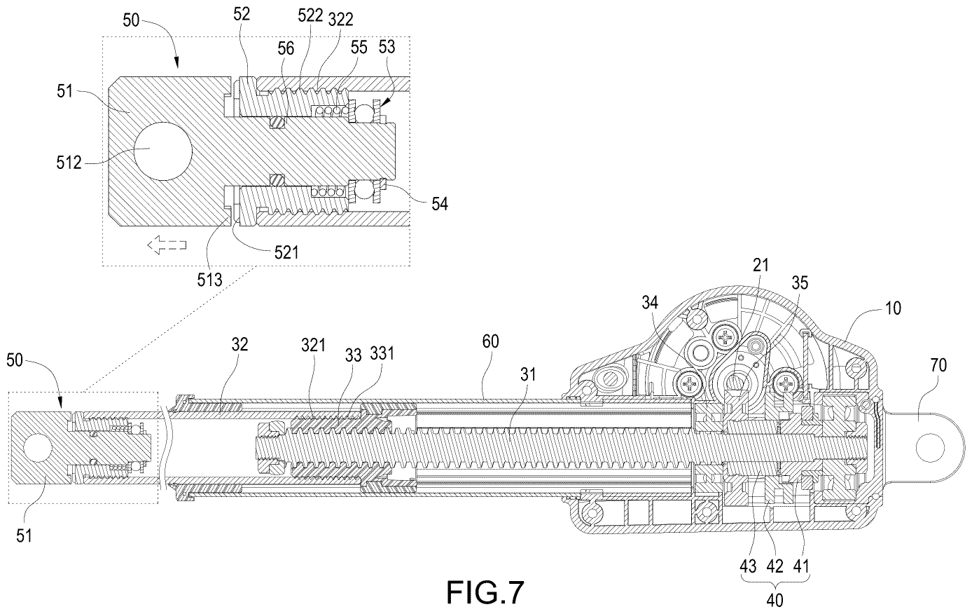

Please continue to refer to FIGS. 7 to 9. In practice, the electric cylinder may be mounted on a medical bed (not illustrated). The medical bed generally includes an upper section, a middle section, and a lower section that are interconnected. The rear bracket 70 is connected to the middle section of the medical bed through a pin, and the end joint 51 of the release structure 50 is connected to the lower section of the medical bed through a pin inserted into the through hole 512. When it is necessary to clean or perform related work in the space below the medical bed, the lower section of the medical bed may be lifted upward. At the same time, the end joint 51 and the connection seat 52 of the release structure 50 are released (see FIG. 7). At this moment, the retaining ring 54 and the bearing member 53 move together leftward. Since the connection seat 52 and the inner tube 32 are connected by threads, and the nut 33 and the inner tube 32 are also connected by threads, while the rear bracket 70 and the end joint 51 are fixed and cannot rotate, the nut 33 and the inner tube 32 rotate together around the lead screw 31 and move along with the end joint 51, thereby quickly lifting the lower section of the medical bed.

When the hand is released, the end joint 51 is pushed rightward by the elastic force of the return spring 55. The end joint 51 and the connection seat 52 cannot rotate relative to each other due to the engagement of the first engagement portions 513 with the second engagement portions 521. The end joint 51 transmits the thrust to the connection seat 52, the connection seat 52 transmits the thrust to the inner tube 32 through the threaded connection, and the inner tube 32 transmits the thrust to the nut 33 through the threaded connection. The nut 33 is threadedly connected to the lead screw 31. However, since the electric cylinder itself is equipped with a brake, the lead screw 31 cannot rotate, and thus the nut 33 cannot rotate either. Therefore, the inner tube 32 does not move rightward.

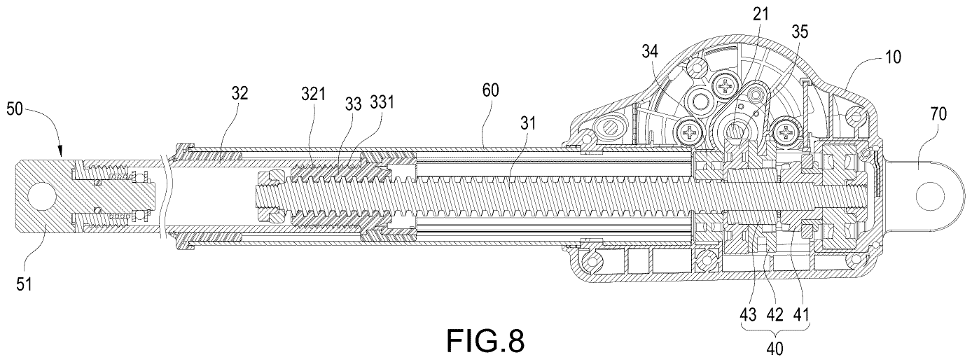

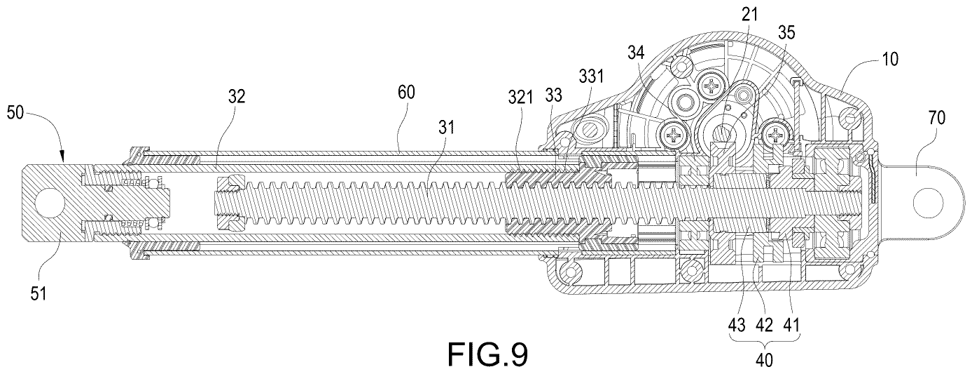

In addition, when manual retraction is required (see FIG. 8), the actuating assembly 45 is driven by pivoting the handle 44 to move the clutch wheel 42 leftward along the axial direction of the guide member 43. The clutch wheel 42 is thereby disengaged from the fixed wheel 41, such that the inner tube 32 may be manually pressed, causing the lead screw 31 to rotate and allowing the inner tube 32 to retract into the outer tube 60 (see FIG. 9).

The foregoing description illustrates only preferred embodiments of the present disclosure and is not intended to limit the scope of the present disclosure. Other equivalent modifications or variations made in accordance with the spirit of the present disclosure shall fall within the scope of the present disclosure.

What is claimed is:

1. A release structure of an electric cylinder, the electric cylinder comprising an inner tube, the release structure being disposed on the inner tube, the release structure comprising:
an end joint comprising a head and a shaft extending from the head, wherein a plurality of first engagement portions are disposed on the head;
a connection seat sleeved on the shaft and connected to the inner tube, the connection seat being provided with a plurality of second engagement portions, the second engagement portions being respectively operable to engage with or disengage from the first engagement portions; and
a bearing member sleeved on the shaft and disposed at one side of the connection seat;
wherein, in a non-locking state, the first engagement portions and the second engagement portions are disengaged, such that the connection seat and the inner tube are rotatable relative to the end joint, and in a locking state, the first engagement portions and the second engagement portions are engaged, such that the end joint and the connection seat move together with the inner tube.

2. The release structure of the electric cylinder according to claim 1, wherein the bearing member comprises a stationary portion and a rotating portion movably connected to the stationary portion, the stationary portion being fixed to the shaft, and the rotating portion abutting against the connection seat.

3. The release structure of the electric cylinder according to claim 1, further comprising a return spring, the return spring being sleeved on the shaft and elastically held between the connection seat and the bearing member.

4. The release structure of the electric cylinder according to claim 1, further comprising a sealing ring, wherein the shaft is provided with a groove, and the sealing ring is disposed in the groove.

5. The release structure of the electric cylinder according to claim 1, wherein an end of the shaft away from the head is provided with a retaining groove, and the retaining groove is configured to receive a retaining ring, such that the bearing member is held in place on the shaft.

6. The release structure of the electric cylinder according to claim 1, wherein each of the first engagement portions is an engagement block, and each of the second engagement portions is an engagement groove matched with the engagement block.

7. The release structure of the electric cylinder according to claim 1, wherein the bearing member is a thrust bearing.

8. The release structure of the electric cylinder according to claim 1, wherein the head is cylindrical and provided with a through hole in a radial direction of the head.

9. An electric cylinder, comprising:
a housing;
an electric motor connected to the housing;
a transmission mechanism connected to the housing and driven by the electric motor, the transmission mechanism comprising a lead screw, an inner tube, and a nut, the nut being connected to one end of the inner tube and threadedly engaged with the lead screw for transmission;
a quick-release mechanism sleeved on the lead screw; and
a release structure disposed at another end of the inner tube, the release structure comprising an end joint, a connection seat, and a bearing member, the end joint comprising a head and a shaft extending from the head, a plurality of first engagement portions being disposed on the head, the connection seat being sleeved on the shaft and connected to the inner tube, the connection seat being provided with a plurality of second engagement portions, the second engagement portions being respectively operable to engage with or disengage from the first engagement portions, the bearing member being sleeved on the shaft and disposed at one side of the connection seat; wherein, in a non-locking state, the first engagement portions and the second engagement portions are disengaged, such that the connection seat and the inner tube are rotatable relative to the end joint, and in a locking state, the first engagement portions and the second engagement portions are engaged, such that the end joint and the connection seat move together with the inner tube.

10. The electric cylinder according to claim 9, wherein two ends of the inner tube are respectively provided with a first internal thread and a second internal thread, the nut is provided with a first external thread fixedly threaded with the first internal thread, and an outer peripheral surface of the connection seat is provided with a second external thread fixedly threaded with the second internal thread.

11. The electric cylinder according to claim 9, further comprising an outer tube and a rear bracket, wherein one end of the outer tube is connected to the housing and extends circumferentially around the transmission mechanism, and the rear bracket is connected to the housing and disposed at a rear side of the transmission mechanism.

12. The electric cylinder according to claim 9, wherein the electric motor comprises a worm, and the transmission mechanism further comprises a bearing and a worm gear, the lead screw passing through the bearing and being supported in the housing, and the worm gear being sleeved on the lead screw and engaged with the worm for transmission.

13. The electric cylinder according to claim 12, wherein the quick-release mechanism comprises a fixed wheel, a clutch wheel, and a guide member, the guide member and the fixed wheel being sequentially sleeved on the lead screw and accommodated inside the housing, and the clutch wheel being movably sleeved on the guide member.

14. The electric cylinder according to claim 13, wherein the quick-release mechanism further comprises a handle and an actuating assembly, the handle being pivotally connected to the housing, and the actuating assembly being disposed inside the housing and connected to the handle and the clutch wheel.
